(19) United States
(12) Patent Application Publication
(10) Pub. No.: US 2014/0207648 A1
(43) Pub. Date: Jul. 24, 2014

(54) LEVERAGED INSTRUMENT COMPUTER-IMPLEMENTED TRADE MANAGEMENT SYSTEM TO PROVIDE LONG-TERM EXPECTED RETURNS FOR DAILY REBALANCE INSTRUMENTS, SUCH AS ETFS OR FUNDS

(71) Applicant: Steven M.H. Wallman, Great Falls, VA (US)

(72) Inventor: Steven M.H. Wallman, Great Falls, VA (US)

(73) Assignee: FOLIOfn, Inc., McLean, VA (US)

(21) Appl. No.: 14/159,643

(22) Filed: Jan. 21, 2014

Related U.S. Application Data
(60) Provisional application No. 61/754,305, filed on Jan. 18, 2013.

(51) Int. Cl. G06Q 40/04

(52) U.S. Cl. CPC G06Q 40/04
USPC 705/37

(57) ABSTRACT

A computer-implemented system enables performance of leveraged instruments, such as leveraged ETFs, to track their design parameters for longer durations than currently possible. The computer-implemented method issues sells and buys of the leveraged instrument on a daily basis to return the instrument back to an expected value, and to credit or debit cash on a daily basis, such that a combination of the instrument position and the cash position taken together provides an actual return close to the theoretical stated return. This strategy involves bringing the leveraged holding back to an equal value of the unleveraged ETF at the time the leveraged ETF is rebalanced—generally at the close of trading on any given day. This technique allows investors to hold the leverage only through the day, and realize the losses and gains of the leverage that day, and resets the position for trading for the following market day.

### RELATED APPLICATION

This application claims priority to U.S. Patent Provisional Application No. 61/754,305 filed Jan. 18, 2013 with the same title and by the same inventor.

### BACKGROUND

The present invention relates generally to computer implemented instrument trading systems, and more particularly to a computer implemented instrument trading system for leveraged instruments.

Leveraged and Inverse Leveraged Exchange Traded Funds (ETFs) have been a problem for investors since they were first offered. Leveraged and Inverse Leveraged ETFs are described as indexed products designed to return a multiple of an index, or an inverse multiple of an index. For example, an ETF may be designed to return three times the daily return of the S&P500, or twice the inverse of the daily return of the Nasdaq 100, such that if the S&P500 increased 3% on a day and the Nasdaq100 increased 2% that day, then the first ETF would increase 9% in value and the second would lose 4% in value. Although these ETFs perform reasonably well if held for a specific day, they fail significantly to provide their stated returns over longer periods. An example of the issue is show in Table 1.

TABLE 1

| | ETF designed to provide 3 | |
|---|---|---|
| | times the daily return of | Nasdaq100 |
| | the Nasdaq100 index | (index) |
| Day 1 Start Price | 100.00 | 100.00 |
| Day 1 Price Movement | 30.00% | 10.00% |
| Day 1 End Price | 130.00 | 110.00 |
| Day 2 Start Price | 130.00 | 110.00 |
| Day 2 Price Movement | −27.00% | −9.00% |
| Day 2 End Price | 94.55 | 100.00 |
| Day 3 Start Price | 94.55 | 100.00 |
| Day 3 Price Movement | −15.00% | −5.00% |
| Day 3 End Price | 80.36 | 95.00 |
| Day 4 Start Price | 80.36 | 95.00 |
| Day 4 Price Movement | 22.11% | 7.37% |
| Day 4 End Price | 98.12 | 102.00 |

The longer the holding period and the more volatile the market the more disconnected the ETF actual return is from the stated return.

The present invention is therefore directed to the problem of developing a system and method to enable leveraged instruments, such as leveraged ETFs, to more accurately track their stated design parameters or goals.

### SUMMARY OF THE INVENTION

The present invention solves these and other problems by inter alia providing a computer-implemented trade management system for leveraged instruments that holds the instrument only for short period of times, thereby maintaining the performance of the instrument on its stated design performance goals.

According to one aspect of the present invention, a computer-implemented method for trading leveraged instruments includes the following steps. A computer creates an open account for an investor, which open account includes: i) an instrument with an original position; and ii) a cash position or margin being permitted in the account, thereby creating a leveraged instrument. After the original position runs during a trading day and at an end of the trading day, the computer obtains an index value and a current value of the instrument from a market interface. The computer then calculates a trade based on a differential between the current value of the instrument and the index value, and then creates a trading order to be executed at the closing based on the calculation using the margin or cash available in the account. The trading order is sent via a market interface to a market for execution. The new instrument position is then maintained for the next trading day. The computer then determines whether the investor closed the new instrument position, and if not performs the same steps, otherwise the process ends, wherein a result is that a combination of the instrument position and the cash in the account will provide over a timeframe sought by the investor, a leveraged return sought by the investor.

According to another aspect of the present invention, an apparatus for trading leveraged instruments includes an investor computer, a database, a central server and a market interface all coupled via the Internet or another public or private network. The investor computer sends and receives investor data about the investor's account. The database stores the investor data received from the investor, which investor data includes an original position of an instrument and an amount of cash or margin to include in the account, thereby creating the leveraged instrument, such as a leveraged exchange traded fund. The central server interacts with the investor computer and the database. The central server issues sell orders and buy orders of the leveraged instrument on a daily basis to return the leveraged instrument back to an expected value and to credit or debit cash on a daily basis, such that a combination of a position of the leveraged instrument and a cash position taken together provide an actual return close to a theoretical stated return.

The central server also: (i) creates an open account for an investor from data sent by the investor computer, which open account includes: an original position of the instrument; and a cash position or margin being permitted in the account; (ii) after the original position of the instrument runs during a trading day and at an end of the trading day, obtains an index value and a current value of the instrument; (iii) calculates a trade based on a differential between the current value of the instrument and the index value using the margin or cash available in the account; (iv) creates a trading order to be executed at the closing based on the calculating; (v) sends the trading order to a market for execution; (vi) maintains a new position of the instrument for the next trading day; and (vii) determines whether the investor closed the new position of the instrument, and if not returns to step (ii), otherwise end the process, wherein a result is that a combination of the position of the instrument and the cash in the account will provide over a timeframe sought by the investor, a leveraged return sought by the investor. The market interface receives trading orders from the central server and sends market data to the central server, said market data including an index value and a current value of the instrument.

According to another aspect of the present invention, a non-transient computer readable media has stored thereon the aforementioned a computer-implemented methods for trading leveraged instruments.

Other advantages and aspects of the present invention will be apparent upon review of the following drawings and description.

### BRIEF DESCRIPTION OF THE DRAWINGS

FIG. 1 depicts an exemplary embodiment of a computerized trading system for implementing the methods of the present invention set forth herein according to one aspect of the present invention.

FIG. 2 depicts an exemplary embodiment of a computer-implemented method for managing leveraged instruments according to another aspect of the present invention.

### DETAILED DESCRIPTION

The present invention comprises a computer-implemented system that enables the performance of a leveraged instrument, such as a leveraged ETF, to track its design parameters for longer durations. The computer implemented method issues sells and buys of the leveraged instrument, such as a leveraged ETF, on a daily basis to return the instrument or security back to an expected value and to credit or debit cash on a daily basis, such that a combination of the instrument position and the cash position taken together provide an actual return close to the theoretical stated return. This novel strategy involves bringing the leveraged holding back to an equal value of the unleveraged ETF at the time the leveraged ETF is rebalanced—generally at the close of trading on any given day. This technique essentially allows an investor to hold the leverage only through the day, and realize the losses and gains of the leverage that day, and resets the position for trading for the following market day. This can be calculated with a multiplier (the one day unit value % gain) and the share quantities for each security. An example of the solution in practice is shown in Table 2.

TABLE 2

| | ETF designed to provide 3 | |
|---|---|---|
| | times the daily return of | Nasdaq100 |
| | the Nasdaq100 index | (index) |
| Day 1 Start Price | 100.00 | 100.00 |
| Day 1 Price Movement | 30% | 10% |
| Day 1 End Price | $130.00 | 110.00 |
| Sell Order to realign | $130 − 110 = $20 | |
| Sell $ Amt placed in Cash | $20.00 | |
| ETF Position at Day End | $130 − $20 = $110.00 | |
| After Order | | |
| Total Position (ETF plus cash) | $20 + $110 = $130 | |
| after Transaction | | |
| Day 2 Start Price | ETF Position: $110.00 | 110.00 |
| Day 2 Price Movement | −27% | −9% |
| Day 2 End Price | $80.30 | 100.10 |
| Buy Order to realign | $80.30 − $100.10 = $−19.80 | |
| Buy $ Amt subtracted from cash | $19.80 | |
| ETF Position at Day End | $80.30 + $19.80 = $100.10 | |
| After Order | | |
| Total Position (ETF plus cash) | $100.10 + ($20 − $19.80) = | |
| after Transaction | $100.30 | |
| | (3× the index return) | |
| Day 3 Start Price | ETF Position: $100.10 | 100.10 |
| Day 3 Price Movement | −15% | −5.00% |
| Day 3 End Price | $85.085 | 95.095 |
| Buy Order to realign | $85.085 − $95.095 = $10.01 | |
| Buy $ Amt subtracted from cash | $−10.01 + $.20 = $−9.81 | |
| ETF Position at Day End | $85.085 + $10.01 = $95.095 | |
| After Order | | |
| Total Position (ETF plus cash) | $95.095 − $9.81 = $85.285 | |
| after Transaction | (3× the index return of | |
| | −4.905% (or 100 − 95.095)) | |

Exemplary Implementation

Generating Orders

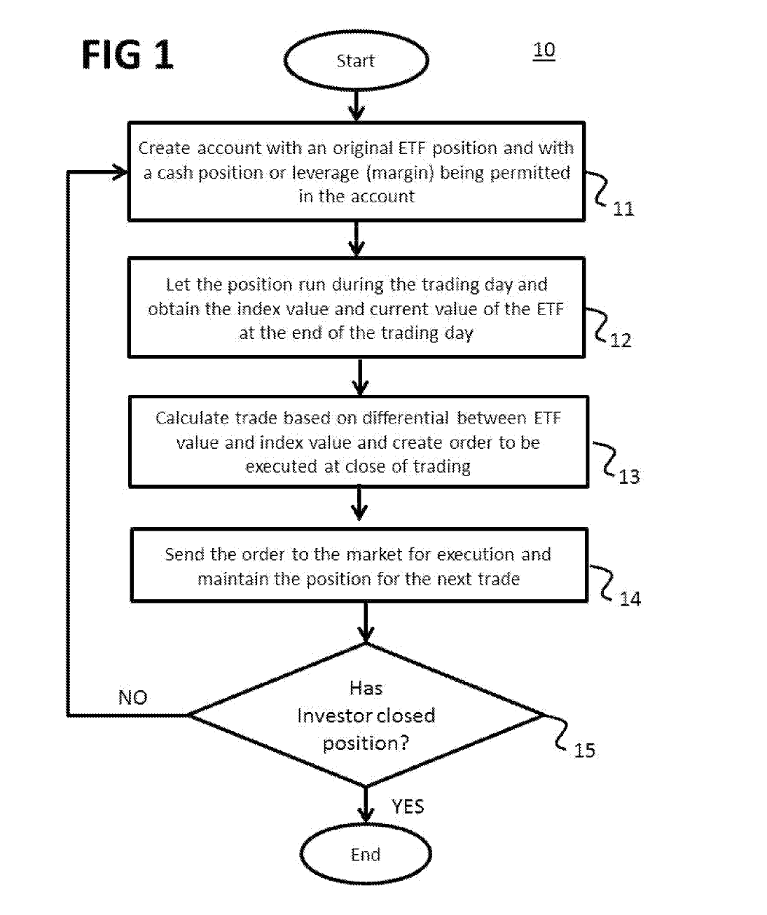

Turning to FIG. 1, shown therein is a computer-implemented method 10 for managing leveraged ETFs or other leveraged instruments. The method begins with an open account containing: i) an original ETF position; and ii) a cash position or leverage (margin) being permitted in the account (step 11). The position would then run during the trading day and at the end of the trading day the computer implemented system would obtain from available data sources the index value and the then current value of the ETF (step 12). The computer would then calculate the trade based on the differential between the ETF value and the index value and create an order to be executed at close as noted above (step 13). The order would be sent to the market for execution and the position would then be maintained as noted above for the next trade (step 14). The process would be repeated each day until the investor closed the position. So in step 15, the process determines whether the investor closed the position, and if not returns to step 11, otherwise the process ends. The result is that the combination of the ETF position and the cash in the account will provide, over the timeframe sought by the investor, the leveraged return sought by the investor.

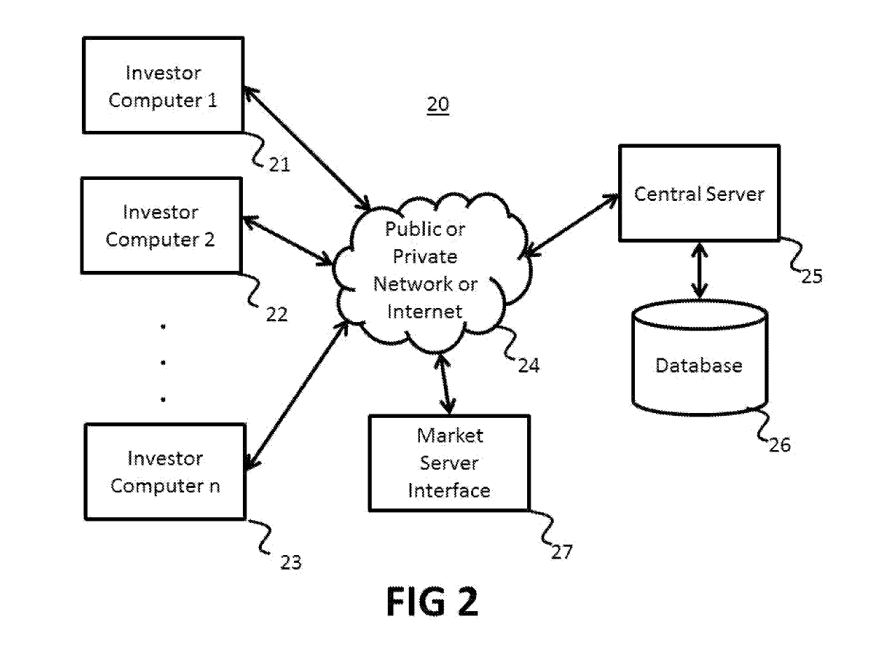

Shown in FIG. 2 is an exemplary embodiment of a computerized system 20 for implementing the method depicted in FIG. 1. For example, investors create accounts with leveraged ETFs using computers 21-23. Any number of computers could be used in this system. Communications with the central server 25 occur via a network 24, which can be a private network, public network, Internet or some other communication device. Central server 25 performs all calculations and obtains all trading data via market server interface 27. Central server 25 creates all buy and sell orders and sends them for execution via market server interface 27. All data is maintained in database 26.

What is claimed is:

1. A computer-implemented method for a trading leveraged instrument comprising returning a leveraged instrument using a computer back to an equal value of an unleveraged instrument at a time the leveraged instrument is rebalanced by the computer at a close of trading on any given day, thereby allowing an investor to hold leverage only through a trading day, and realize any losses or gains of the leverage that day, and resetting a position using a computer for trading for a following market day, which is calculated by the computer with a multiplier and share quantities for the instrument.

2. The computer implemented method according to claim 1, further comprising:
a) creating with a computer an open account for an investor, said open account including: an instrument with an original position and margin being permitted in the account, wherein a combination of the instrument and margin forms a leveraged instrument;
b) after the original position runs during a trading day and at an end of the trading day, obtaining by the computer an index value and a current value of the instrument;
c) calculating with a computer a trade based on a differential between the current value of the instrument and the index value;
d) creating with a computer a trading order to be executed at the closing based on the calculating based on the margin available in the account;
e) sending the trading order to a market for execution;
f) maintaining a new position for the instrument for the next trading day; and
g) determining by the computer whether the investor closed the new position for the instrument, and if not returning to step b), otherwise ending the process, wherein a result is that a combination of a position of the instrument and cash in the account will provide over a timeframe sought by the investor, a leveraged return sought by the investor.

3. The computer implemented method according to claim 2, wherein the investor includes a plurality of investors having a plurality of open accounts and the computer performs the method for each of the plurality of investors.

4. The computer implemented method according to claim 1, wherein the instrument includes an exchange traded fund.

5. An apparatus for trading leveraged instruments comprising:
a) an investor computer to send and receive investor data;
b) a database for storing investor data received from the investor, said investor data including an instrument and an amount of margin to include in the account thereby forming a leveraged instrument; and
c) a central server to interact with the investor computer and the database, said central server to issue sell orders and buy orders of the leveraged instrument on a daily basis to return the leveraged instrument back to an expected value and to credit or debit cash on a daily basis, such that a combination of a position of the leveraged instrument and a cash position taken together provide an actual return close to a theoretical stated return.

6. The apparatus according to claim 5, wherein the central server:
a) creates an open account for an investor from data sent by the investor computer, said open account including: i) an original position of the leveraged instrument; and ii) margin being permitted in the account;
b) after the original position of the leveraged instrument runs during a trading day and at an end of the trading day, obtains an index value and a current value of the leveraged instrument;
c) calculates a trade based on a differential between the current value of the leveraged instrument and the index value;
d) creates a trading order to be executed at the closing based on the calculating and margin available in the account;
e) sends the trading order to a market for execution;
f) maintains a new position for the leveraged instrument for the next trading day; and
g) determines whether the investor closed the new position for the leveraged instrument, and if not returns to step b), otherwise ends the process, wherein a result is that a combination of the new position and cash in the account will provide over a timeframe sought by the investor, a leveraged return sought by the investor.

7. The apparatus according to claim 5, further comprising:
a market interface to receive trading orders from the central server and to send market data to the central server, said market data including an index value and a current value of the leveraged instrument.

8. The apparatus according to claim 5, wherein the instrument includes an exchange traded fund.

9. The apparatus according to claim 5, further comprising a plurality of investor computer, wherein each investor has an open account and the computer performs the method for each of the plurality of investors.

10. A non-transient computer readable media having stored thereon a computer-implemented method for trading leveraged instruments causing a central server to interact with an investor computer and a database, wherein said central server issues sell orders and buy orders of the leveraged instrument on a daily basis to return the leveraged instrument back to an expected value and to credit or debit cash on a daily basis, such that a combination of a position of the leveraged instrument and a cash position taken together provide an actual return close to a theoretical stated return.

11. The non-transient computer readable media according to claim 10, wherein said central server:
a) creates an open account for an investor, said open account including: i) an original position of an instrument; and ii) a margin being permitted in the account, thereby creating a leveraged instrument;
b) after the original position runs during a trading day and at an end of the trading day, obtains by the computer an index value and a current value of the instrument;
c) calculates with a computer a trade based on a differential between the current value of the instrument and the index value;
d) creates with a computer a trading order to be executed at the closing based on the calculating and margin available in the account;
e) sends the trading order to a market for execution;
f) maintains a new position for the instrument for the next trading day; and
g) determines by the computer whether the investor closed the new position for the instrument, and if not returns to step b), otherwise ends the process, wherein a result is that a combination of the position of the instrument and the cash in the account will provide over a timeframe sought by the investor, a leveraged return sought by the investor.

12. The non-transient computer readable media according to claim 10, wherein the investor includes a plurality of investors having a plurality of open accounts and the method is performed for each of the plurality of investors.

13. The non-transient computer readable media according to claim 10, wherein the instrument includes an exchange traded fund.

14. The non-transient computer readable media according to claim 10, wherein each investor has an open account and the method is performed for each of the plurality of investors.
